(19) United States
(12) Patent Application Publication
(10) Pub. No.: US 2004/0243435 A1
(43) Pub. Date: Dec. 2, 2004

(54) Medical information management system

(75) Inventor: Tommie Williams, Euless, TX (US)

Correspondence Address: HAYNES AND BOONE, LLP, 901 MAIN STREET, SUITE 3100, DALLAS, TX, 75202, US

(73) Assignee: Med-Sched, Inc., Euless, TX

(21) Appl. No.: 10/447,625

(22) Filed: May 29, 2003

(51) Int. Cl. G06F 17/60

(52) U.S. Cl. 705/2; 705/8

(57) ABSTRACT

A medical information management system is provided for managing medical information over a communications network. The system includes a server having a program, wherein the program has a plurality of modules including a client profile module, a scheduling module, a prescription module, an insurance module, a collaboration module, an administration module, and a communications module. The system further includes a client interface for adding and viewing medical information and one or more medical facility interfaces for adding and viewing medical information.

### BACKGROUND

The present disclosure relates generally to the field of medical practice and medical services, and more specifically to a medical services delivery system that utilizes an integrated, electronic communications system for interfacing with participants in the medical practice.

As the healthcare industry becomes more complex, healthcare providers continuously search for tools for improving patient care while, simultaneously, creating highly efficient procedures to use when interacting with patients, other healthcare providers, and support services. Insurers and managed healthcare organizations also need accurate and timely patient information to control healthcare costs and ensure patient service. Pharmacies require current patient information and an automated way to ensure that prescriptions are safely filled. Finally, patients need a secure, effective, time-saving system for managing healthcare information. Therefore, an integrated system is needed to manage a network of extended relationships within the medical industry and to leverage the information maintained by each of the network participants to better serve patients.

### SUMMARY

In response to the above identified needs, a new and unique medical information management system is provided. In one embodiment, a system is provided for managing medical information over a communications network. The system includes a server having a program, wherein the program has a plurality of modules including a client profile module, a scheduling module, a prescription module, an insurance module, a collaboration module, an administration module, and a communications module. The system further includes a client interface for adding and viewing medical information and one or more medical facility interfaces for adding and viewing medical information.

In another embodiment, a method is provided for interfacing network participants including a client, a medical facility, a medical insurer, and a pharmacy using a computer program. The method includes providing a first interface to the client for scheduling an appointment with the medical facility; providing a second interface to the client for maintaining a client profile; providing a third interface to the client for obtaining a prescription medication; providing a fourth interface to the client for managing medical insurance claims; and providing a fifth interface to the client for communicating with network participants.

### BRIEF DESCRIPTION OF THE DRAWINGS

FIG. 1 provides a block diagram of a communication system employing one embodiment of the present invention.

FIG. 2 provides a block diagram of a patient record used in the communication network of FIG. 1.

FIG. 3 a is a flowchart of a client node interface routine performed in one embodiment of the communication system of FIG. 1.

FIG. 3b is a flowchart of a profile management module used in the communication system of FIG. 1.

FIG. 4 is a screen display of a client interface used in the client node interface routine of FIG. 3a.

FIG. 5 is a flowchart of a health care provider (HCP) interface routine performed in one embodiment of the communication system of FIG. 1.

FIG. 6 is a screen display of a HCP interface used in the HCP interface routine of FIG. 5.

FIG. 7 is a flowchart of a scheduling module used in the communication system of FIG. 1.

FIG. 8 is a flowchart of an office visit performed in the communication system of FIG. 1.

FIG. 9a is a flowchart of a patient prescription module used in the communication system of FIG. 1.

FIG. 9b is a flowchart of a HCP prescription module used in the communication system of FIG. 1.

FIG. 10 is a flowchart of an insurance module used in the communication system of FIG. 1.

FIG. 11 is a flowchart of a communications module used in the communication system of FIG. 1.

FIG. 12 is a flowchart of an administration module used in the communication system of FIG. 1.

### DETAILED DESCRIPTION

For the purposes of promoting an understanding of the principles of the present invention, reference will now be made to the embodiments, or examples, illustrated in the drawings, and specific language will be used to describe the same. It will nevertheless be understood that no limitation of the scope of the invention is thereby intended. Any alterations and further modifications in the described embodiments, and any further applications of the principles of the inventions a described herein are contemplated as would normally occur to one skilled in the art to which the invention relates.

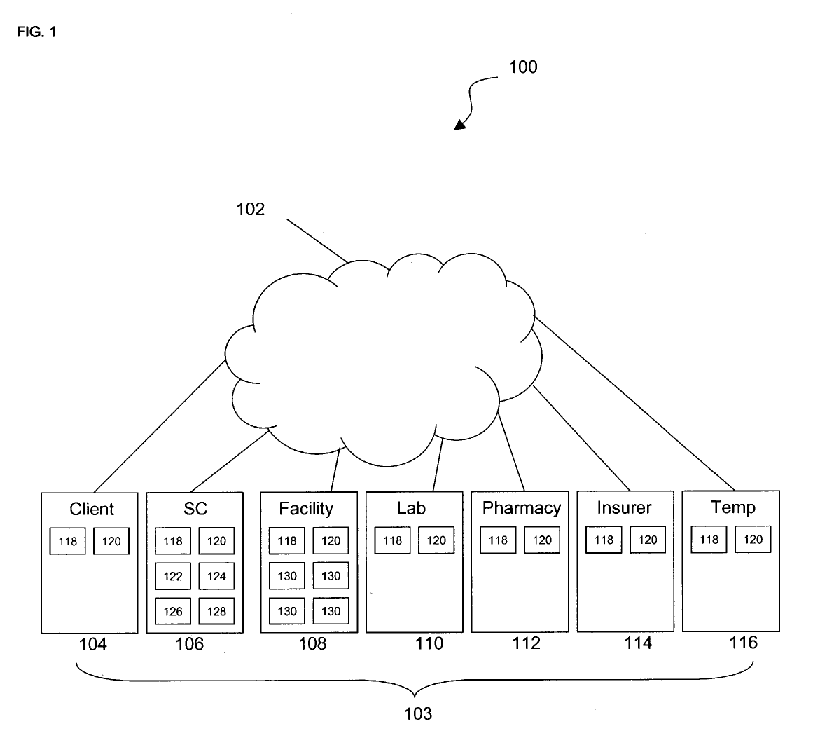

Referring first to FIG. 1, the reference numeral 100 designates a communication system including a computer network 102. Connected to the computer network 102 are participants 103 which can include a client node (“client”) 104, a service center (“SC”) 106, a medical facility (“facility”) 108, a laboratory (“lab”) 110, a pharmacy 112, an insurance company (“insurer”) 114, and a temporary staffing agency (“temp”) 116. Additional participants can be connected to the computer network 102 to expand the services provided by the communication system 100. The computer network 102 can be, for example, the public Internet or a private intranet. Each of the participants in the computer network 102 can include an interface device 118 such as a keyboard and monitor and a network communications device 120, such as an Ethernet card. The SC 106 can include a computer processor 122, a storage device 124, a server 126, and a program 128. The SC 106 can be located at the facility 108, the lab 110, the pharmacy 112, the insurer 114, the temp agency 116, or a separate location. Each facility within the system 100 can include multiple health care professionals (HCP's) 130 such as doctors, nurses, and clerical staff. Each HCP 130 can have different system identification information, and access to information within the system can be limited based upon authority levels associated with the HCP's 130 identification information. For example, a physician can have an authority to view and approve patient prescription requests, but the same authority can be withheld from the office receptionist.

In one embodiment, the program 128 can include a client profile module, a client interface module, a HCP interface module, an insurance module, a scheduling module, a prescription module, and an administration modules. Each module is described in detail in this disclosure. Other modules can be added to the program to accommodate the participants in the network.

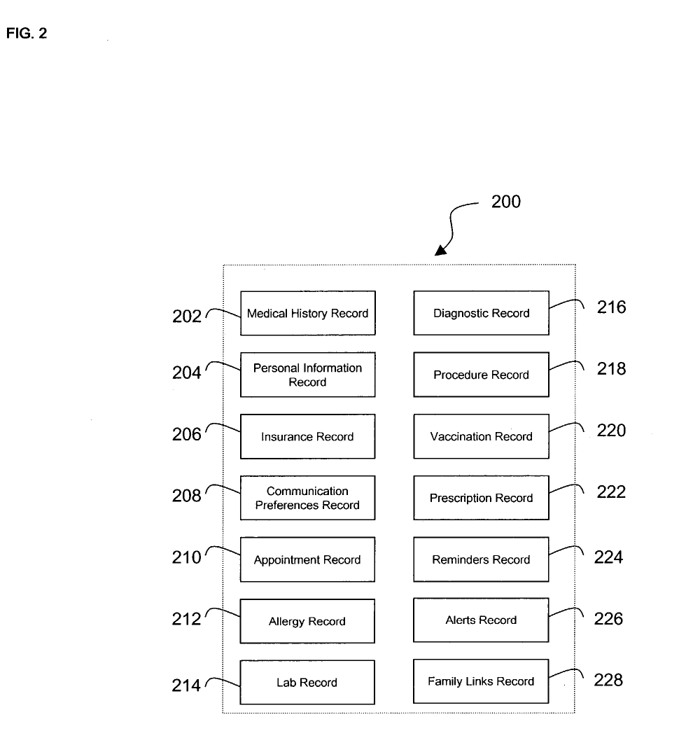

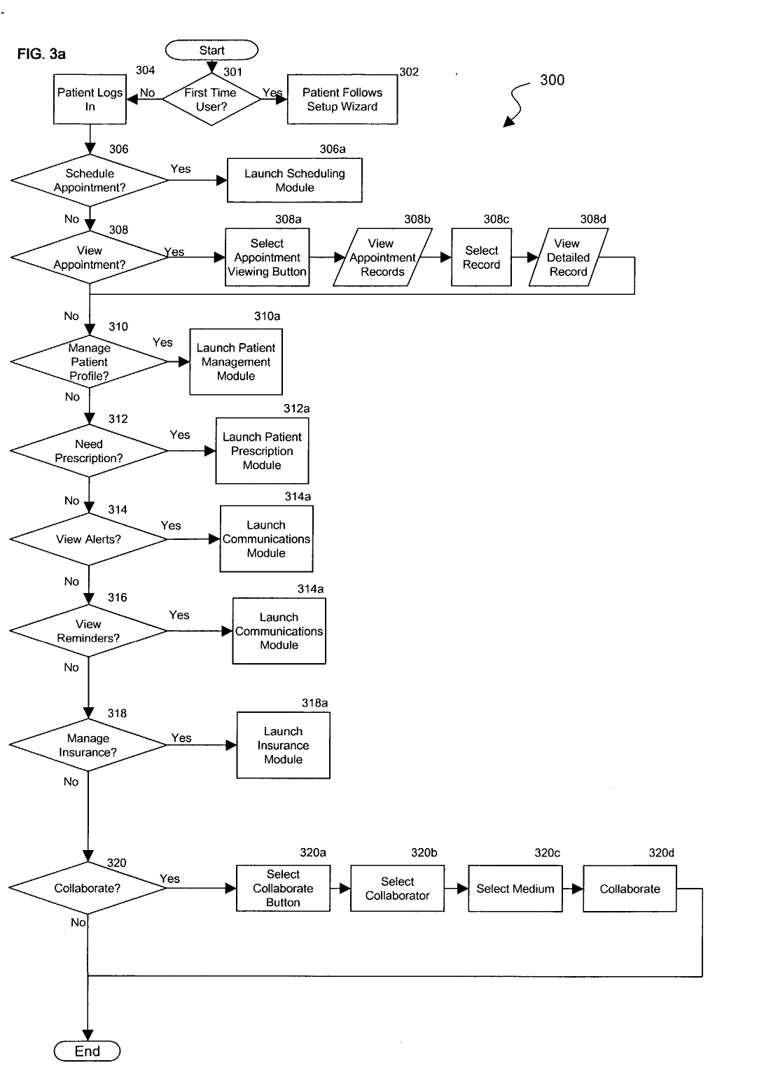

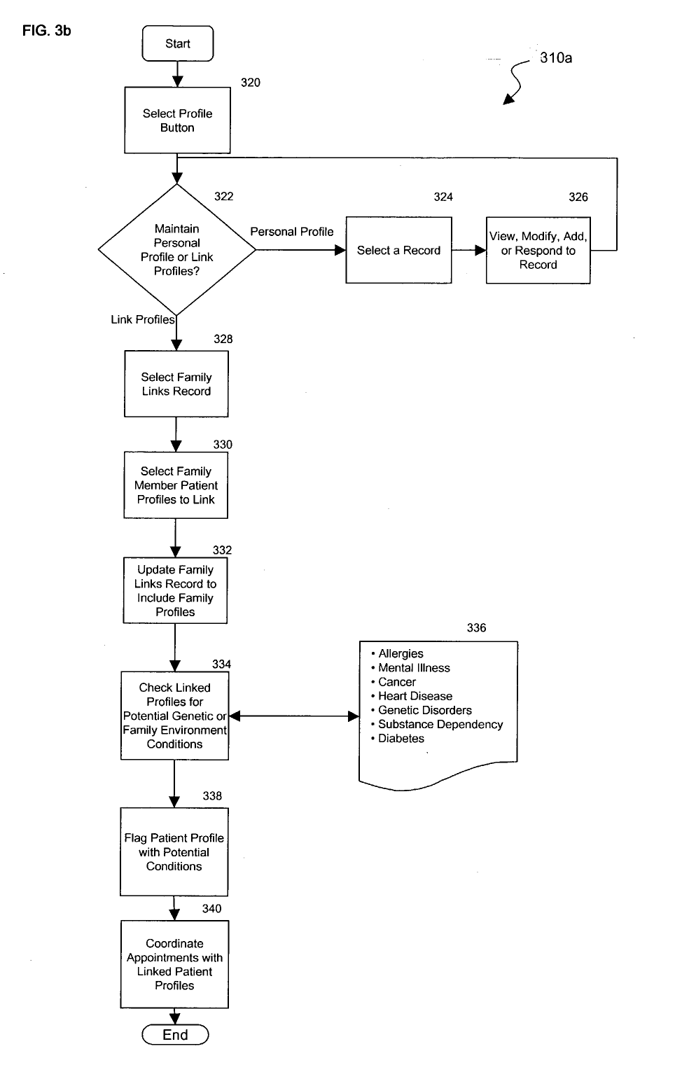

Referring now to FIG. 2, in one embodiment, the client node 104 corresponds to a patient, and each patient is assigned at least one patient profile 200 which is a structured repository residing within the network 100 for all medical related data associated with the patient. As the client node and the other participants 103 interface over the communication system 100, the data in the patient profile 200 can be viewed, modified, updated, and acted upon. The patient profile 200 can include a patient, medical history record 202, a personal information record 204, an insurance record 206, a communication preferences record 208, an appointment record 210, an allergy record 212, a lab record 214, a diagnostic record 216, a procedure record 218, a vaccination record 220, a prescription record 222, a reminders record 224, an alerts record 226, and a family link record 228. Other records can be added as patient or system needs warrant. Access to portions of the patient profile 200 can be restricted to specific participants 103 to protect patient confidentiality or to prevent tampering with the records. 100231 Referring now to FIG. 3a, a client node interface procedure 300 can be performed to interact with the computer network 102. In this example, the client node 104 corresponds to a patient of a physician's office facility. If at step 301 it is determined that the patient is a first time user, the client node 104 follows a setup wizard 302 which establishes a patient profile 200 and registers the user. If at step 301 the patient is not a first time user, execution proceeds to step 304 where the patient provides login identification information.

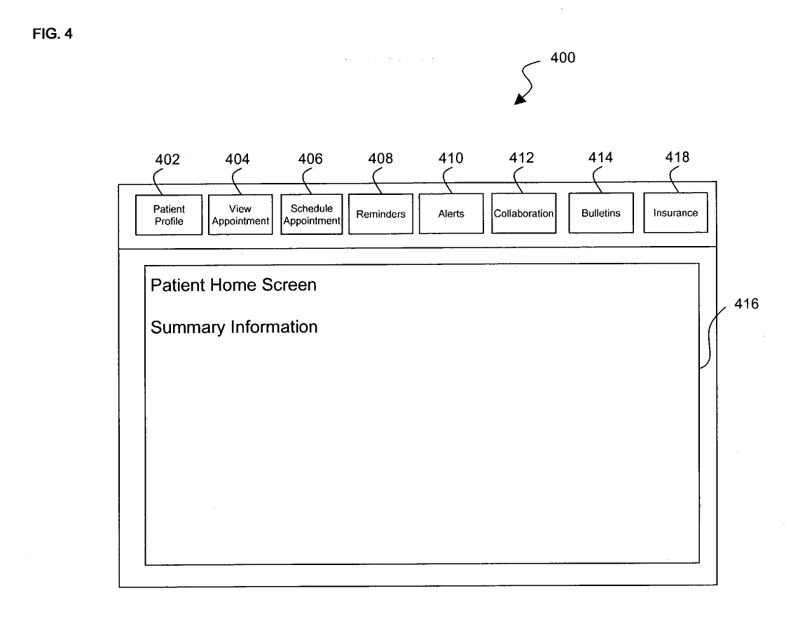

Referring now to FIG. 4, after logging into the system 100, a home screen 400 presents the client node 104 with several options. The home screen 400 can include a Patient Profile button 402, a View Appointments button 404, a Schedule Appointments button 406, a Reminders button 408, an Alerts button 410, a Collaboration button 412, and a Bulletins button 414, and an Insurance button 418. The home screen can further include buttons to link the patient directly to information stored within the patient profile 200 or to access other functions of the system 100. The buttons 402-414 permit the client node 104 access to additional screens through which the client node 104 can retrieve or enter data. The home screen can also include a summary information section 416 which can be customized and personalized by the client node 104 to display information pertinent to that client node 104.

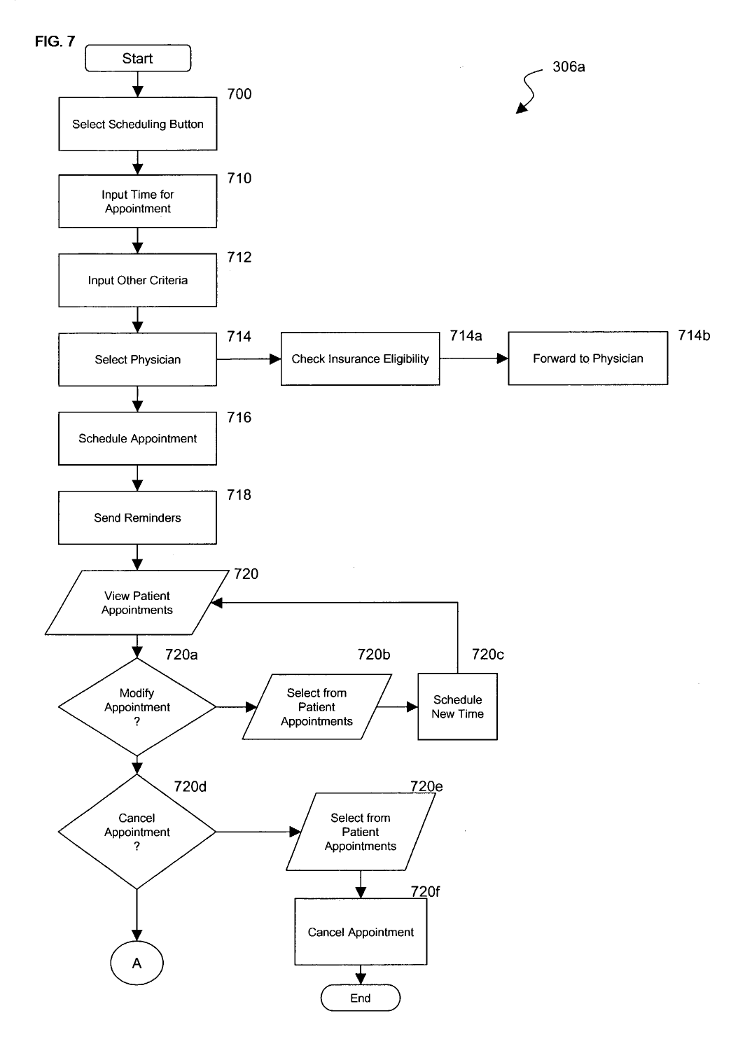

For instance, referring back to FIG. 3a, if at step 306 the client node 104 chooses to schedule an appointment, the client node 104 launches the scheduling module 306a further described with FIG. 7. The scheduling module 306a allows the client node 104 to enter scheduling criteria such as the reason for the appointment, the desired time for the appointment, the location of appointment, the insurance to be used, and the doctor to be seen. After the scheduling criteria is entered, execution proceeds to step 308 where the client node 104 can view scheduled, rejected, and pending appointments. Selecting the View Appointments button at step 308a launches steps 308b-308d in which the client node 104 can enter the patient profile 200 to view summary or detailed appointment records. Appointment modifications and cancellations can also be performed as further described in FIG. 7.

Referring still to FIG. 3a, execution proceeds to step 310 wherein if the client node 104 chooses to manage a patient profile, the client node 104 launches a profile management module 310a (FIG. 3b). Referring now to FIG. 3b, execution then proceeds to step 320 wherein the client node 104 selects the profile button. If at step 322 the client chooses to manage the patient profile 200, execution proceeds to step 324 wherein a record is selected. At step 326, the record can be viewed, modified, added to, responded to or otherwise managed according to the authority granted the client node 104. If the client node 104 chooses to link patient profiles, execution proceeds to step 328 wherein the client node 104 selects the family links record. At step 330, the client node 104 can select the patient profile for each family member and establish a link. At step 332, the family links record 228 of the patient profile 200 is updated to include family member profiles. Family member profiles can be included by linking the patient profiles, by copying records from one patient profile into another, or by any other methods of communicating patient information known in the art. Execution proceeds to step 334 wherein all linked profiles are screened against the list of step 336 which includes diagnoses with a potential genetic or family environment cause such as, but not limited to allergies, mental illness, cancer, heart disease, genetic disorders, substance dependency, and diabetes. Proceeding next to step 338, the patient profile 200 can be flagged with the potential conditions based upon diagnoses found in the linked family member profiles, and preventative measures can be implemented by a HCP 130 with access to the patient profile 200. Execution then proceeds to step 340, wherein the linked profiles can also be used to coordinate HCP 130 appointments for multiple family members.

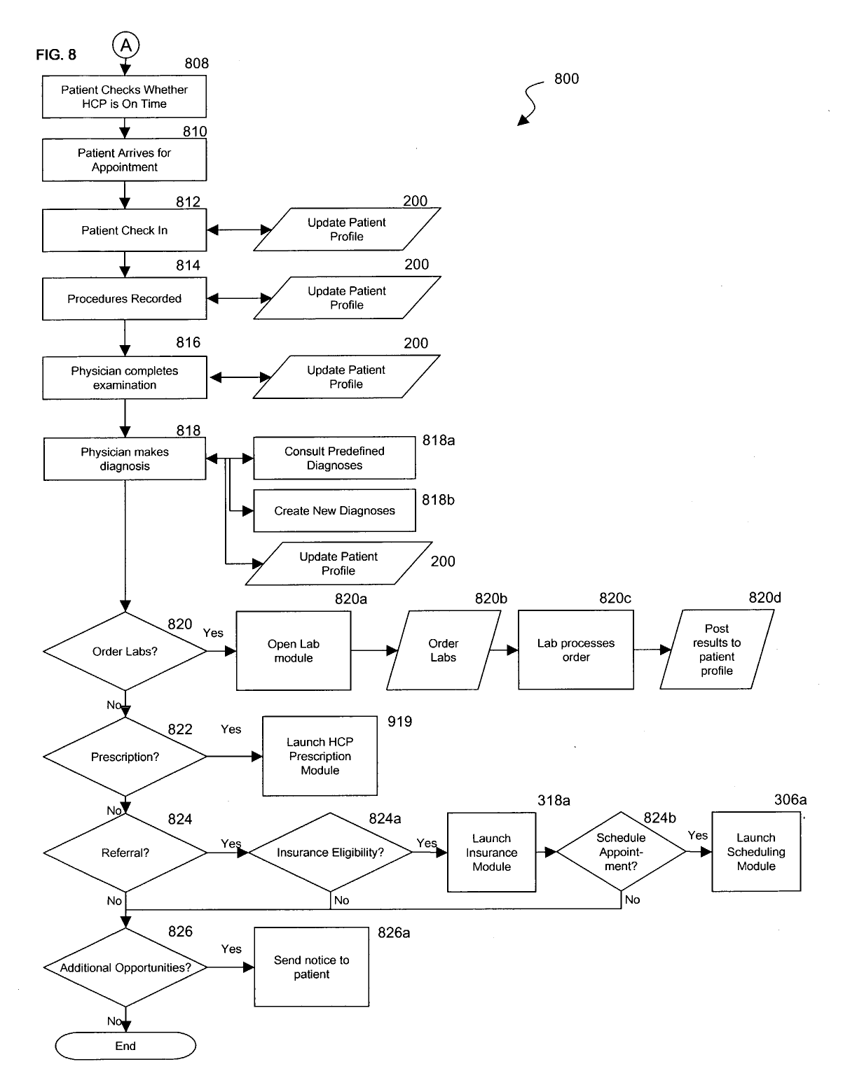

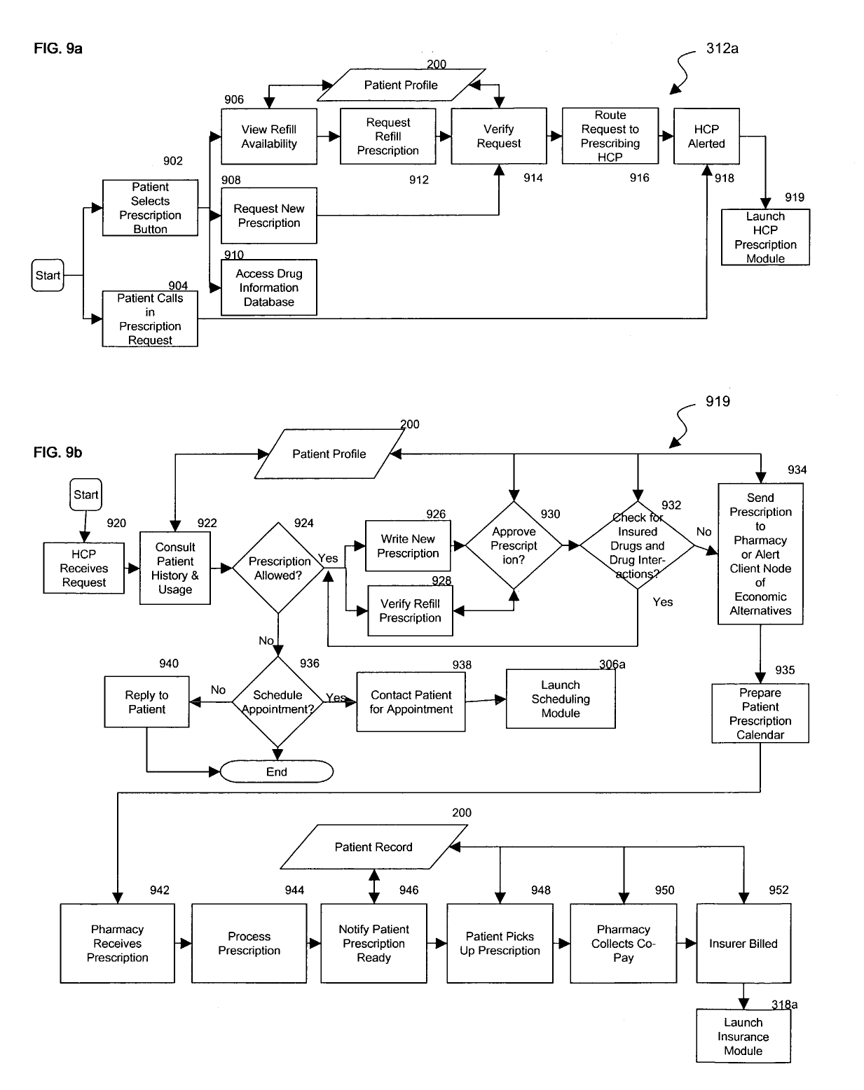

Referring again to FIG. 3a, if at step 312 the client node 104 requires a new or refill prescription, the patient prescription module 312a (FIG. 9a) can be launched. Referring now to FIG. 9a, in one embodiment, the prescription module 312a launches when at step 902 the client node 104 selects the Prescription button which allows the client node 104 to access steps 906, 908, and 910 to view refill availability, request a new prescription, or access a drug information database. If the client node 104 chooses, at step 908, to request a new prescription or, at step 312, to request a refill, the patient's profile 200 is updated, and the client node 104 verifies the request at step 914. Execution then proceeds to step 916 wherein the request is routed to the prescribing HCP 130. At step 918, the program 128 alerts the HCP 130, and execution proceeds to step 919 (FIG. 9b) wherein the HCP prescription module is launched

Referring now to FIG. 9b, the HCP receives the prescription request at step 920. Whether a client node 104 requests a prescription via the system 100 or phones in to the HCP 130 to request a prescription as in step 904, the process continues at step 922 with the HCP 130 consulting the patient profile 200 including the medical history record 202, the allergies record 212, and the prescription record 222. If, at step 924, the HCP 130 allows the prescription, a new prescription can be written at step 926, or a refill can be verified at step 928. If at step 930 the prescription is approved, then at step 932 the HCP 130 can be provided with a list of brand name pharmaceuticals and/or generic alternatives from which to select based upon the patient's insurance coverage. Also at step 932, the program 128 consults the patient profile 200 to automatically check for allergic reactions or potential interactions with other pharmaceuticals. Similarly, a prescription can be screened against a list of known allergies, or where family member profiles are linked together, can be screened against family member allergies to ward off potential allergic reactions. If the prescription cannot be approved at step 930, the HCP 130 can decide at step 938 to contact the client node 104 to schedule an appointment or can, at step 940, reply to the client node 104 explaining why the prescription cannot be written. The program 128 can include security features which permit only an authorized HCP 130 to approve prescriptions at step 930. At step 934, the prescription is sent to the pharmacy 112 selected in the patient profile 200 or the client node 104 may be alerted to other more economical alternatives such as utilizing the insurer's mail-order pharmacy program.

At step 935, a prescription calendar may be sent to the patient. The prescription calendar can include, for example, an image of each of the prescribed pharmaceuticals that a patient is scheduled to take on a particular day or at a particular hour. The image may convey information about the shape, color, texture, size, or delivery mechanism of the prescribed pharmaceutical. For example, the calendar can include an image of a round, blue tablet; a red liquid, or a white plastic inhaler. Because the patient profile 200 can include all of the pharmaceutical drugs prescribed to a patient, the prescription calendar can provide a visual reminder of all of the pharmaceutical drugs a patient should take in a given day or within given periods of a day. As the patient's prescriptions change, a new calendar can be provided.

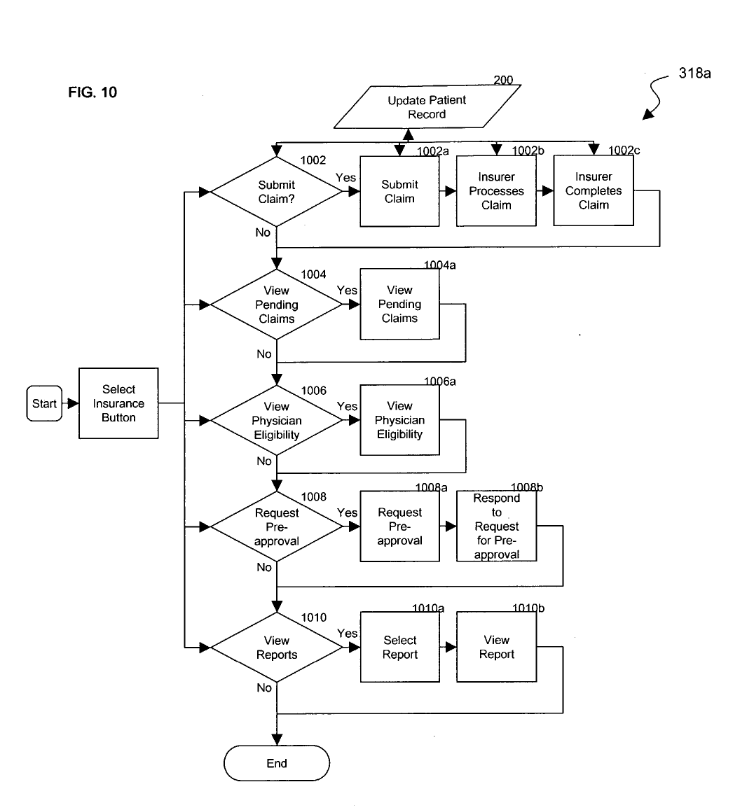

After the pharmacy 112 receives the prescription at step 942, the prescription is processed at step 944, and the client node 104 is notified at step 946 that the prescription is ready. The pharmacy 112 can receive information from the patient profile 200 which allows the pharmacy 112 to contact the client node 104 based upon the communication preferences record 208 the client node 104 has established. When the client node 104 picks up the prescription at step 948, the pharmacy 112 collects a co-pay at step 950, and the insurer 114 can be billed at step 952 by launching the insurance module 318a (FIG. 10). This transaction can be recorded in the patient profile 200.

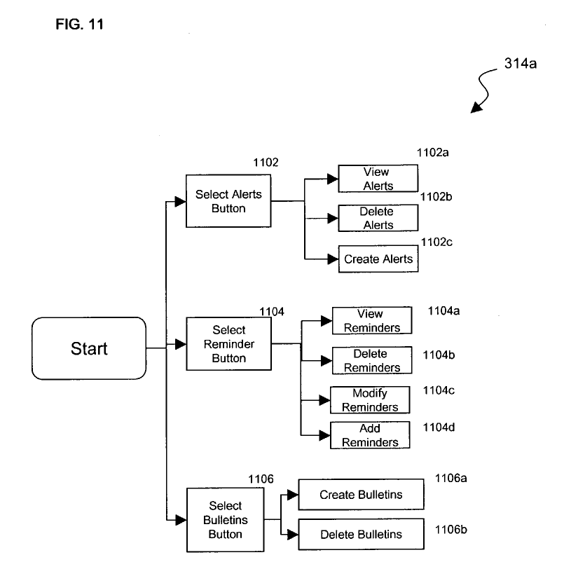

Referring once again to FIG. 3a, if the client node 104 chooses to view alerts at step 314, the client node 104 launches a communications module 314a (FIG. 11) as further described below for FIG. 11.

Referring again to FIG. 3a, if the client node 104 chooses to manage reminders 316, the client node 104 launches the communications module 314a (FIG. 11) as further described below for FIG. 11.

Referring again to FIG. 3a, if the client node 104 chooses to manage insurance at step 318, the client node 104 can launch the insurance module 318a (FIG. 10). Referring now to FIG. 10, the insurance module 1000 allows a client node 104 to interact with one or more insurers 114 which can include, for example, indemnity plan providers, health maintenance organizations (“HMO's”), and preferred provider organizations (“PPO's”). If the client node 104 chooses to submit a claim at step 1002, a series of steps 1002a-1002c are performed which allow the client node 104 to submit the claim and the insurer 114 to process the claim, complete the claim, and update the patient profile 200. The processing and completion of the claim may also trigger communication between the insurer 114 and the client node 104 which can be performed using the program 128. The client node 104 can also choose to view pending claims at step 1004, view physician eligibility at step 1006, or request procedure pre-approval at step 1008. Finally, the client node 104 can also view reports at step 1010 which can detail, for instance, the status of all of a HCP's 130 claims. The insurance module 1000 can also provide other information or functions related to the delivery of medical services. The insurance module can also be utilized by a HCP 130 to submit and manage insurance claims.

Referring again to FIG. 3a, the client node 104 can also choose to collaborate at step 320 with other participants 103 in the system 100. Selecting Collaboration button at step 320a initiates a series of steps 320b-320d which allow the client node 104 to select the collaboration participants; select the forum such as chat room, email, video conference, audio conference; and then collaborate with the participants regarding for example, how best to proceed with a patient's treatment.

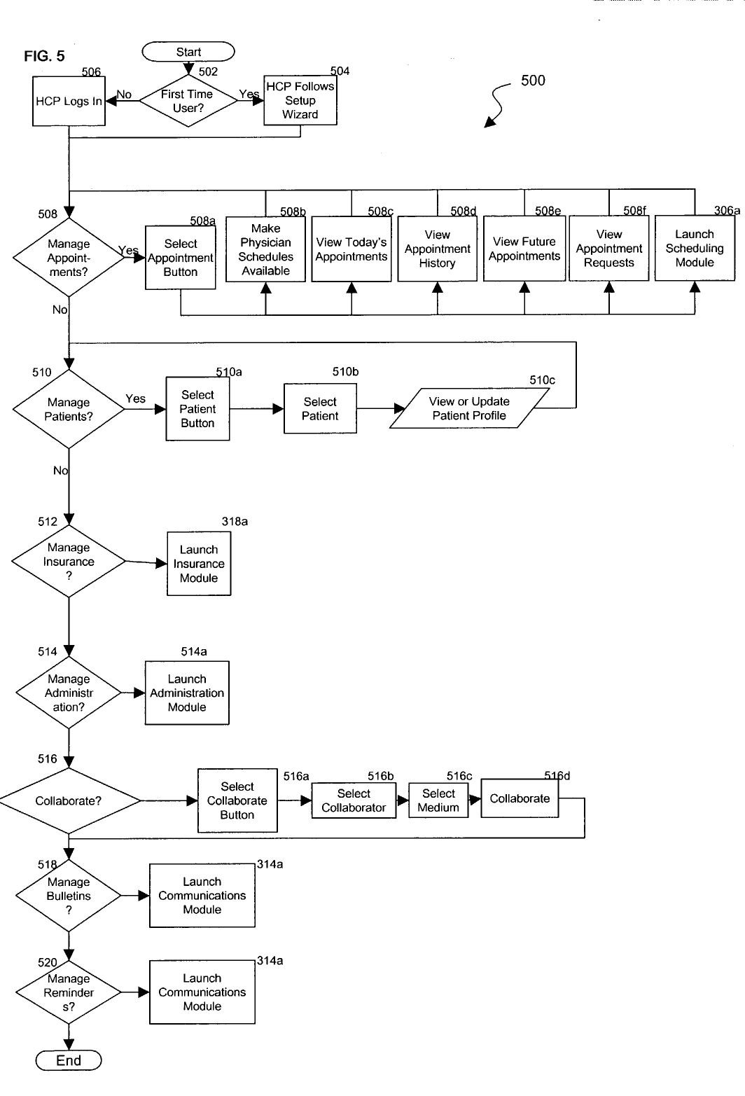

Referring now to FIG. 5, a HCP interface procedure 500 can be performed to interact with the computer network 102. If at step 502, the HCP 130 is a first time user, the HCP 130 follows a setup wizard at step 504 to register the HCP 130. If the HCP 130 is not a first time user, the HCP 130 provides login identification information at step 506.

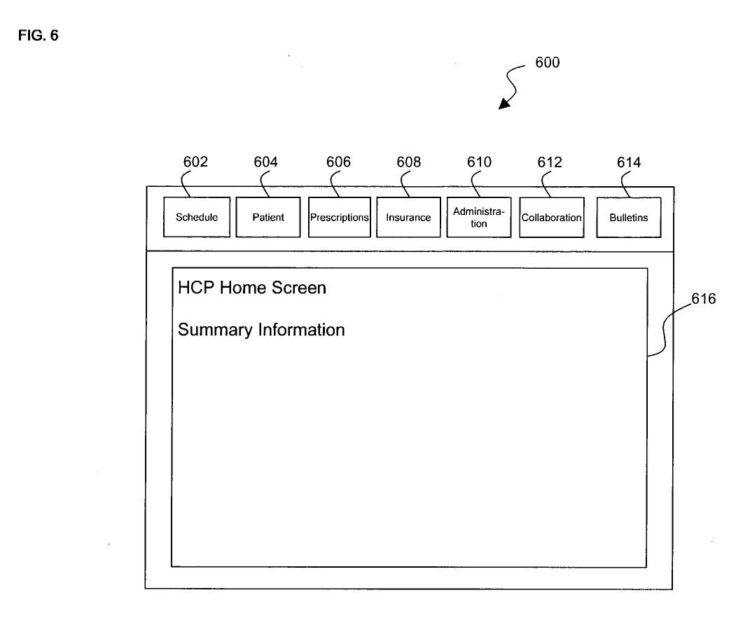

Referring now to FIG. 6, after logging into the system 100, a home screen 600 presents the HCP 130 with several options. The home screen 600 can include a Schedule button 602, a Patient button 604, a Prescriptions button 606, an Insurance button 608, an Administration button 610, a Collaboration button 612, and a Bulletins button 614. The home screen can further include buttons to link the HCP 130 directly to stored information or to access other functions of the system 100. The buttons 602-614 permit the HCP 130 access to additional screens through which the HCP 130 can retrieve or enter data. The home screen can also include a summary information section 616 which can be customized and personalized by the HCP 130 to display information pertinent to that HCP 130. For example, a receptionist's summary information section may include patient appointment requests awaiting approval, while a physician's summary information may include collaboration requests from other physicians or patients.

For instance, referring back to FIG. 5, if the HCP 130 chooses to manage appointments at step 508, selecting the Schedule button at step 508a allows the HCP 130 to perform functions 508b-f which can include posting information related to a HCP's 130 schedule such as open appointments and whether the HCP 130 is on time for the current day's appointments. Also, the HCP 130 can view the current day's appointments, future appointments, or appointment histories. Finally, the HCP 130 can launch the scheduling module at step 306a (FIG. 7) to approve requested appointments or schedule an appointment for a patient.

Referring again to FIG. 5, if the HCP 130 chooses to manage patient information at step 510, selecting the Patient button at step 5 10a allows the HCP 130 to select a patient at step 510b and access the patient's profile at step 510c including viewing or modifying patient appointments, updating procedures and diagnoses, or writing prescription. The HCP 130 can also categorize patients with selected attributes such as a registered status, a specific insurer, or a specific diagnosis.

If the HCP 130 chooses to manage insurance at step 512, the HCP 130 can launch the insurance module 318a as further described in FIG. 10.

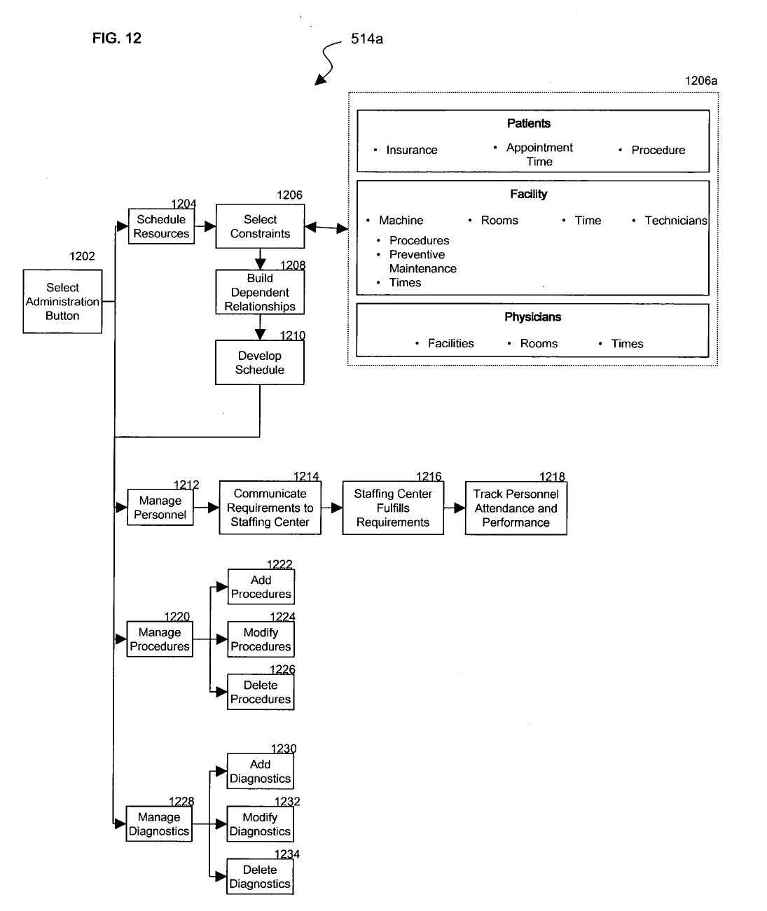

If the HCP 130 chooses to manage administration at step 514, the HCP can launch the administration module 514a as further described in FIG. 12.

The HCP 130 can also choose to collaborate at step 516 with other participants in the system 100. Selecting Collaboration button at step 516a initiates a series of steps 516b-320d which allow the HCP 130 to select the collaboration participants; select the forum such as chat room, email, video conference, or audio conference; and then collaborate with the participants regarding for example, how best to proceed with a patient's treatment.

Referring again to FIG. 5, the HCP 130 can choose to manage bulletins at step 518 which allows the HCP 130 to enter the communications module 314a (FIG. 11).

The HCP 130 can also enter the communications module 314a to manage reminders at step 520. Referring now to FIG. 7, the scheduling module 306a for scheduling a patient appointment with a HCP 130 is described. In this embodiment, the client node 104 can select the scheduling button at step 700, and at step 710, input a time for the appointment. Then, at step 712, the client node 104 can input other criteria such as the reason for the appointment, type of insurance to be used, and a desired geographic location. At step 714, the client node 104 can be presented with a list of HCP's 130 that meet the desired criteria and can select from the list or chooses a different HCP 130. At step 716, the appointment can then be recorded on the HCP's schedule. The HCP 130 can choose to review and approve all appointments before they are scheduled. After an appointment is scheduled, the data associated with the appointment record in the patient profile 200 can allow a medical facility to generate automated reminders at step 718 by posting to the client node's reminders record and by using the communications preferences record 208. The reminders may simply notify the client node 104 of the time and place for the appointment, but the patient profile 200 allows the reminders to address specific patient needs. For example, based upon the procedures scheduled for an appointment, a client node 104 may receive a patient reminder to fast for a period of time before the appointment or avoid certain foods before the appointment. Further, reminders may include attached forms that may be filled out by a new patient prior to the appointment and returned to the medical facility. Additionally, automatic reminders may be sent describing the procedures to be performed, so that the patient can come to the appointment prepared with informed questions.

Still referring to FIG. 7, after an appointment is scheduled, a client node 104 or HCP 130 can access the patient profile 720 to view, reschedule or cancel an appointment at steps 720a-720f.

Referring now to FIG. 8, the office visit process 800 begins at step 808, wherein based upon the appointment record in the patient profile 200, a client node 104 can log on to view whether the HCP 130 is on schedule or is delayed. Notices can be sent by pager or email to alert a client node 104 that a HCP 130 is behind schedule or has been called to an emergency. These features provide valuable time-saving information for a patient. At step 810, the patient arrives for the scheduled appointment. When the patient checks in at step 812, the patient profile 200 is updated. As the HCP 130 examines the patient, at step 814, the HCP 130 can record the procedures completed in the patient profile 200. When the HCP 130 completes the examination at step 816 and is ready to make a diagnosis at step 818, the HCP 130 can follow steps 818a and 818b to choose from the predefined diagnoses or enter the Administration module and create additional diagnoses. The patient profile 200 is then updated with the diagnosis. At step 820, the HCP 130 can choose to order lab tests or execution can proceed to step 822 wherein the HCP 130 can write a prescription. To order lab tests, a HCP 130 can enter the lab module at step 820a to create the order at step 820b. The lab processes the order at step 818c and posts the results to the patient profile at step 818d. A prescription can be written using the prescription module 900. If the patient is referred to another HCP 130 at step 824, the insurance module 1000 and the scheduling module 700 can be invoked to create the referral appointment. Where a patient's diagnosis and procedure record warrant, an alert may be generated to suggest additional opportunities available to the patient at step 826 such as, support groups and research studies which network participants are currently conducting for which the patient may qualify.

Referring now to FIG. 11, after the communications module 314a is launched by a client node 104 or HCP 130, the alerts button can be selected at step 1102 which allows alerts to be viewed, created or deleted as authority levels permit at step 1102a-1102c. An alert can, for example be used by a physician's office to communicate to a patient population. The communications module 314a can be utilized by the other network participants also.

The client node 104 or HCP 130 can also, at step 1104, select the reminders button which initiates steps 1104a-1104d allowing reminders to be viewed, added, modified, or deleted as authority levels permit. Reminders can be used, for example, to notify patients of upcoming appointments, dietary restrictions, procedure protocols, or other pertinent information. They can also be directed toward a specific patient or group of patients based upon a categorization such as age, gender, or diagnosis.

The HCP 130 can also, at step 1106, select the bulletins button, to initiate steps 1106a and 1106b which allow bulletins to be created or deleted. Facilities such as hospitals or physicians' offices can use bulletins, for example, to notify patients and other HCP's of upcoming facility-sponsored classes such as cardiopulmonary resuscitation (CPR) or child birth preparation.

Referring now to FIG. 12, when the HCP chooses to launch the administration module 514a, execution proceeds to step 1202 wherein the HCP selects the administration button to manage personnel, facility equipment, facility rooms, and personnel tasks. The HCP 130 can manage administrative functions such as authority levels, machine scheduling, room scheduling, personnel scheduling, assigning tasks, temporary services requests, and bulletin maintenance. At step 1204, the HCP can choose to schedule resources which begins at step 1206 with selecting the constraint factors 1206a. The constraint factors 1206a can be categorized. For example, patient constraint factors can include an insurance carrier, desired appointment time, and procedure to be performed. Facility criteria can include available rooms, times, technicians, and machines, where a criteria such as machines can include subcategories such as preventive maintenance schedules and length of procedures. Physician criteria can include, for example, assigned rooms, available times, and assigned facilities.

After selecting the constraint factors 1206a, execution proceeds to step 1208 wherein dependent relationships are built between the constraint factors 1206a. At step 1210, a schedule is built based upon a scheduling algorithm and the constrained relationship between the factors 1206a. Some factors 1206a may be weighted differently than others to prepare the schedule. As one example, a facility may require three physicians to utilize two examination rooms and one machine. Patients may be scheduled to utilize these resources to maximize, for example, the number of patients treated or the financial return on the resources. As another example, a facility may need to schedule patients on six machines constrained by one trained technician and the preventive maintenance schedules for the six machines. Considering additional constraint factors 1206a such as patient desired schedule time, the type and duration of the procedure to be performed, and the patient's insurance coverage, patients can be scheduled to most efficiently and profitably use these resources.

The constrained schedule developed at step 1210 can be used at step 1212 to manage personnel. At step 1214, the schedule can be communicated to a staffing center which will, at step 1216, fill the positions as the schedule requires. Personnel attendance and performance can be tracked and reported at step 1218. The Administration module also allows a HCP 130 at steps 1220-1234 to add, modify, or delete procedure and diagnosis descriptions.

The present invention has been described relative to a number of preferred embodiments. Improvements or modifications that become apparent to persons of ordinary skill in the art only after reading this disclosure are deemed within the spirit and scope of the application. It is understood that several modifications, changes, and substitutions are intended in the foregoing disclosure, and in some instances some features of the invention will be employed without a corresponding use of other features. Accordingly, it is appropriate that the appended claims be construed broadly and in a manner consistent with the scope of the invention.

1. A medical information management system comprising:
a server system having a program, wherein the program has a plurality of modules including a client profile module, a scheduling module, a prescription module, an insurance module, a collaboration module, an administration module, and a communications module;
a client interface for adding and viewing medical information; and
one or more medical facility interfaces for adding and viewing medical information.

2. The system of claim 1 wherein the client profile module comprises one or more client profiles wherein each client profile comprises a plurality of records including a medical history record, a personal information record, an insurance record, a communication preferences record, an appointment record, a primary allergy record, a lab record, a diagnostic record, a procedure record, a vaccination record, a prescription record, a reminders record, an alerts record, and a family links record.

3. The system of claim 2 wherein the family links record provides instructions to search one or more family profiles for genetic or family environment diagnoses and returns the search results to the client profile.

4. The system of claim 3 wherein the one or more family profiles includes one or more family allergy records and wherein the family allergy records are adapted for inclusion in the primary allergy record.

5. The system of claim 1 wherein the scheduling module comprises:
an interface for entering criteria including an appointment time, an appointment reason, an insurance provider; a desired geographic location;
a relational database of healthcare providers, the relational database including a plurality of available appointment times, a specialty, a list of accepted insurance providers, and an office location;
a selection interface for selecting from one or more appointment candidates, wherein the criteria is compared to the relational database to generate the one or more appointment candidates.

6. The system of claim 5 further comprising:
an approval interface for approving the selected appointment candidate.

7. The system of claim 1 wherein the prescription module comprises:
an interface for entering a prescription request;
an interface for a health care provider to consult the client profile module;
an interface for writing a prescription for a prescribed pharmaceutical;
an interface for receiving a prescription request at a first pharmacy.

8. The system of claim 7 wherein the prescription module further comprises:
an interface for selecting an insured pharmaceutical.

9. The system of claim 7 wherein the prescription module further comprises:
an alert that the prescription can be filled more economically by a second pharmacy.

10. The system of claim 7 wherein the prescription module further comprises a prescription calendar wherein the prescription calendar includes an image of the prescribed pharmaceutical.

11. The system of claim 1 wherein the insurance module comprises:
a client insurance policy;
an insurance claim submission interface;
a claim status display;
a pre-approval interface; and
a physician eligibility record,
wherein the physician eligibility record indicates whether the client insurance policy covers a referred specialist.

12. The system of claim 1 wherein the administration module comprises:
one or more constraint factors;
one or more dependent relationships assigned to the one or more constraint factors;
a scheduling algorithm for processing the one or more dependent relationships and the one or more constraint factors; and
a constrained schedule developed by the scheduling algorithm.

13. The system of claim 12 wherein the administration module further comprises:
a staffing center interface for displaying the constrained schedule to a staffing center, wherein the staffing center provides personnel to the medical facility in response to the constrained schedule.

14. The system of claim 13 wherein the one or more constraint factors further comprises a machine preventive maintenance schedule.

15. The system of claim 2 wherein the communications module comprises:
a reminder generator wherein the reminder generator references the communications preferences record and the appointment record to generate a client reminder;
a bulletin generator; and
an alert generator.

16. The system of claim 15 wherein the client reminder includes a date and a time for a scheduled appointment.

17. The system of claim 15 wherein the communications module includes a dietary intake restriction message.

18. The system of claim 15 wherein the alert generator references the communications preferences record and the diagnostic record to generate client opportunity messages.

19. The system of claim 1 further comprising a lab interface for adding and viewing lab test information

20. A method for interfacing network participants including a client, a medical facility, a medical insurer, and a pharmacy using a computer program, the method comprising:
providing a first interface to the client for scheduling an appointment with the medical facility;
providing a second interface to the client for maintaining a client profile;
providing a third interface to the client for obtaining a prescription medication;
providing a fourth interface to the client for managing medical insurance claims; and
providing a fifth interface to the client for communicating with network participants.

21. The method of claim 20 wherein the client profile comprises a plurality of records including a medical history record, a personal information record, an insurance record, a communication preferences record, an appointment record, a primary allergy record, a lab record, a diagnostic record, a procedure record, a vaccination record, a prescription record, a reminders record, an alerts record, and a family links record.

22. The method of claim 20 wherein the fifth interface for communicating with network participants includes displaying messages responsive to the diagnostic record.

23. The method of claim 20 wherein the fifth interface for communicating with network participants includes displaying messages responsive to the appointment record.
